(19) United States
(12) Patent Application Publication
(10) Pub. No.: US 2026/0128310 A1
(43) Pub. Date: May 7, 2026

(54) METHOD FOR MANUFACTURING FREE-STANDING FILM FOR ANODE OF LITHIUM SECONDARY BATTERY AND FREE-STANDING FILM FOR ANODE OF LITHIUM SECONDARY BATTERY MANUFACTURED THROUGH THE SAME

(71) Applicants: HYUNDAI MOTOR COMPANY, Seoul (KR); Kia Corporation, Seoul (KR)

(72) Inventors: Byung Yong Lee, Hwaseong-si (KR); Ik Hyeon Choi, Hwaseong-si (KR); Hyo Min Yoo, Hwaseong-si (KR); Ju Young Jang, Hwaseong-si (KR)

(73) Assignees: HYUNDAI MOTOR COMPANY, Seoul (KR); Kia Corporation, Seoul (KR)

(21) Appl. No.: 19/190,457

(22) Filed: Apr. 25, 2025

(30) Foreign Application Priority Data
Nov. 5, 2024 (KR) 10-2024-0155653

(51) Int. Cl. H01M 4/583; H01M 4/02; H01M 4/04; H01M 4/1393; H01M 4/62; H01M 10/052

(52) U.S. Cl. CPC H01M 4/583; H01M 4/0404; H01M 4/0435; H01M 4/1393; H01M 4/622; H01M 10/052; H01M 2004/021; H01M 2004/027

(57) ABSTRACT

A method for manufacturing a free-standing film an anode, includes obtaining powders for forming the anode by mixing and grinding a composition for forming the anode including an anode active material, a conductive material, and a binder (S1), and forming an anode active material layer through a film forming process using the powders for forming the anode (S2). The binder includes a triblock copolymer including: a soft block that includes an aliphatic or cycloaliphatic diene monomer unit, and exhibits a rubbery phase at a room temperature, a first hard block that is linked to one end of the soft block, includes an ethylenically unsaturated monomer unit containing an aromatic ring, and exhibits a glass phase at a room temperature, and a second hard block that is linked to another end of the soft block, includes an ethylenically unsaturated monomer unit containing an aromatic ring, and exhibits the glass phase at the room temperature, and an average particle diameter (D₅₀) of the binder included in the powders for forming the anode is smaller than an average particle diameter (D₅₀) of the binder included in the composition for forming the anode.

### CROSS-REFERENCE TO RELATED APPLICATION

This application claims the benefit of priority to Korean Patent Application No. 10-2024-0155653 filed in the Korean Intellectual Property Office on Nov. 5, 2024, the entire contents of which are incorporated herein by reference.

### TECHNICAL FIELD

The present disclosure relates to a method for manufacturing a free-standing film for an anode of a lithium secondary battery by employing a triblock copolymer including a soft block and a hard block, and a free-standing film for an anode of a lithium secondary battery, which is manufactured through the same.

### BACKGROUND

A lithium secondary battery has been extensively applied since the lithium secondary battery is first commercialized in 1990s, and continuously spotlighted as an energy storage device which has been mostly researched. The lithium secondary battery has requirements appropriate as an energy source of an electric vehicle due to a higher driving voltage, a higher energy density, a lower self-discharge rate, higher-rate performance, and longer cycle stability.

Nevertheless, the lithium secondary battery applied to the electric vehicle faces three main issues of stability, operating time, and costs. The stability and the operating time may be resolved through the all-solid-state battery, but costs are a factor to interrupt widely applying the lithium secondary battery. Accordingly, many studies and researches have performed to save the costs of the lithium secondary battery.

Reducing energy consumption necessary for manufacturing or increasing the thickness of an electrode is one of the most effective manners to reduce the manufacturing costs of the lithium secondary battery. According to a conventional technology for manufacturing an electrode, slurry, which is prepared by mixing an electrode active material, a polymer binder, and a conductive additive with water or an organic solvent, is casted to a current collector, and the result is dried and compressed to form an electrode. In this case, energy required to prepare the slurry and coat the current collector occupies 50% of energy consumed in the whole manufacturing process. Accordingly, studies and researches haven been performed with respect to a process for manufacturing the electrode in a dry manner without a solvent such that the manufacturing cost of the lithium secondary battery is reduced. Representatively, there has been, as a dry electrode manufacturing process, a technology for manufacturing a cathode of a lithium secondary battery in a drying manner using polytetrafluoroethylene (PTFE). PTFE may have the level of lowest unoccupied molecular orbitals (LUMO) to easily receive electrons. Accordingly, PTFE is electro-chemically unstable under a negative potential environment. Accordingly, an anode of the lithium secondary battery manufactured by employing PTFE as a binder exhibits an inferior cycle stability. In addition, when the anode is manufactured using the PTFE, a PTFE binder is decomposed during an initial charging operation, so the initial efficiency of the lithium secondary battery is lowered.

Even though many studies and researches have been performed on a technology for manufacturing an electrode in a dry manner, the development of a technology for manufacturing an anode in a dry manner to manufacture the anode having an excellent physical property in moldability, electrochemical stability, or tensile force is still insufficient. Accordingly, studies and researches on the technology are required.

### SUMMARY

The present disclosure has been made to solve the above-mentioned problems occurring in the prior art while advantages achieved by the prior art are maintained intact.

An aspect of the present disclosure provides a free-standing film of a lithium secondary battery, capable of being easily formed, stabilized even at a negative potential, and strongly bound with an anode active material by applying a binder including a triblock copolymer including a hard block contributed to an excellent mechanical property and a soft block having flexibility, and being strongly bound to the anode active material and the conductive material by exhibiting excellent tensile force and forming a three dimensional network and a method for manufacturing the same, an anode for the lithium secondary battery including the free-standing film for the anode, and the lithium secondary battery.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for manufacturing a free-standing film for an anode, includes obtaining powders for forming the anode by mixing and grinding a composition for forming the anode including an anode active material, a conductive material, and a binder (S1), and forming an anode active material layer through a film forming process using the powders for forming the anode (S2). The binder includes a triblock copolymer including a soft block, which includes an aliphatic or cycloaliphatic diene monomer unit, and exhibits a rubbery phase at a room temperature, a first hard block, which is linked to one end of the soft block, includes an ethylenically unsaturated monomer unit containing an aromatic ring, and exhibits a glass phase at a room temperature, and a second hard block which is linked to another end of the soft block, includes an ethylenically unsaturated monomer unit containing an aromatic ring, and exhibits the glass phase at the room temperature, and an average particle diameter (D₅₀) of the binder included in the powders for forming the anode is smaller than an average particle diameter (D₅₀) of the binder included in the composition for forming the anode.

According to an aspect of the present disclosure, a free-standing film for an anode, includes a plurality of anode active materials, a plurality of conductive materials, and a binder. The binder includes a tri block copolymer including a soft block, which includes an aliphatic or cycloaliphatic diene monomer unit, and exhibits a rubbery phase at a room temperature, a first hard block, which is linked to one end of the soft block, includes an ethylenically unsaturated monomer unit containing an aromatic ring, and exhibits a glass phase at a room temperature, and a second hard block which is linked to another end of the soft block, includes an ethylenically unsaturated monomer unit containing an aromatic ring, and exhibits the glass phase at the room temperature. The binder has an intermittent column shape to link one anode active material among the plurality of anode active materials or one conductive material among the plurality of conductive materials, to another anode active materials among the plurality of anode active materials or another conductive material among the plurality of conductive materials. The binder has an average width of 50 nm perpendicular to a length direction.

### BRIEF DESCRIPTION OF THE DRAWINGS

The above and other objects, features and advantages of the present disclosure will be more apparent from the following detailed description taken in conjunction with the accompanying drawings:

FIG. 1 is a view schematically illustrating an internal structure of a binder included in a free-standing film for an anode, according to an embodiment of the present disclosure;

FIG. 2 is a view schematically illustrating a method for manufacturing a free-standing film for an anode, according to an embodiment of the present disclosure;

FIG. 3 is a view schematically a mechanism for changing a binder in a manufacturing process of a free-standing film for an anode, according to an embodiment of the present disclosure;

FIG. 4 is a view schematically illustrating a structure in which a binder and an anode active material are formed in a free-standing film for an anode, according to an embodiment of the present disclosure;

FIG. 5 is a view schematically illustrating a structure in which a binder and an anode active material are formed in a conventional free-standing film for an anode employing PTFE as a binder;

FIG. 6 is a view illustrating an SEM image for powders for forming an anode according to Embodiment 1;

FIGS. 7 and 8 are a view illustrating an SEM image for a free-standing film for an anode according to Embodiment 1;

FIG. 9 is a view illustrating an SEM image for a free-standing film for an anode according to Comparative example 1;

FIG. 10 is a view illustrating an SEM image for a free-standing film for an anode according to Comparative example 2; and

FIG. 11 is a graph illustrating a data obtained by measuring tensile force of a free-standing film for an anode according to Embodiment 1, and Comparative examples 1 and 2.

### DETAILED DESCRIPTION

Hereinafter, the present disclosure will be described in more detail for the understanding of the present disclosure. In this case, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

In the present disclosure, the term a “monomer unit” may represent a component, a structure or a material thereof derived from a monomer. More specifically, the monomer unit may refer to a repeating unit constituting a polymer, as a monomer is introduced to participate in a polymerization reaction, when the polymer is polymerized.

### <Method for Manufacturing Free-Standing Film for Anode>

The present disclosure provides a method for manufacturing a free-standing film for an anode.

Conventionally, there has been, as a dry electrode manufacturing process, a technology for manufacturing a cathode of a lithium secondary battery in a drying manner using polytetrafluoroethylene (PTFE). PTFE may have the level of lowest unoccupied molecular orbitals (LUMO) to easily receive electrons. Accordingly, PTFE is electro-chemically unstable under a negative potential environment. Accordingly, an anode of the lithium secondary battery manufactured by employing PTFE as a binder exhibits an inferior cycle stability. In addition, when the anode is manufactured using the PTFE, a PTFE binder is decomposed in an initial charging operation, so the initial efficiency of the lithium secondary battery is lowered.

Accordingly, recently, for a binder electro-chemically having stability even at a negative potential, there has been developed, a technology for employing a triblock copolymer including a soft block, which is derived from an aliphatic or cycloaliphatic diene monomer, and exhibits a rubbery phase at a room temperature, a first hard block, which is linked to one end of the soft block, and derived from an ethylenically unsaturated monomer containing an aromatic ring, and exhibits a glass phase at a room temperature, and a second hard block which is linked to another end of the soft block and derived from an ethylenically unsaturated monomer containing an aromatic ring, and exhibits a glass phase at a room temperature. However, according to this technology, a process for improving a physical poetry is taken a longer time, and the free-standing film for the anode, which is manufactured, exhibits lower tensile force.

The present disclosure proposes employing the above-described triblock copolymer as a binder, and mixing an anode active material, a conductive material, and the binder with each other by a grinder to reduce the whole processes and improve the tensile force of the free-standing film for the anode manufactured.

The method for manufacturing the free-standing film for the anode according to an embodiment of the present disclosure includes the steps for obtaining powders for forming the anode by mixing and grinding compositions for forming the anode at least including an anode active material, a conductive material, and a binder (S1), and forming an anode active material layer through a film forming process using the powders for forming the anode (S2). The binder includes a triblock copolymer including a soft block, which includes an aliphatic or cycloaliphatic diene monomer unit, and exhibits a rubbery phase at a room temperature, a first hard block, which is linked to one end of the soft block, includes an ethylenically unsaturated monomer unit containing an aromatic ring, and exhibits a glass phase at a room temperature, and a second hard block which is linked to another end of the soft block, includes an ethylenically unsaturated monomer unit containing an aromatic ring, and exhibits a glass phase at a room temperature. An average particle diameter (D₅₀) of the binder included in the powders for forming the anode is smaller than an average particle diameter (D₅₀) of a binder included in a composition for forming the anode.

Hereinafter, the steps included in the method for manufacturing the free-standing film for the anode according to an embodiment of the present disclosure will be described in detail.

### 1. ‘S1’

The method for manufacturing the free-standing-film for the anode may include the step for obtaining powders for forming the anode by mixing and grinding compositions for forming the anode including the anode active material, the conductive material, and the binder (S1).

According to an embodiment of the present disclosure, the anode active material may include at least one selected from the group consisting of a carbon-based active material, a silicon-based active material, a metal-based active material allowing the alloy with lithium, and a lithium containing active material.

According to an embodiment of the present disclosure, the carbon-based active materials may include, for example, graphite, hard carbon, soft carbon, or graphene. The graphite may be artificial graphite, natural graphite, a mixture of artificial graphite and natural graphite, natural graphite coated with artificial graphite, or the combination thereof. The carbon-based active material allows a consecutively and repeatedly oxidation and reduction reaction, as a crystal structure is less changed during the insertion and extraction of a lithium ion, thereby implementing a lithium secondary battery having a higher capacity and a longer life span.

According to an embodiment of the present disclosure, the silicon-based active material may be, for example, Si, SiOm, a Si—C complex, a Si-Q alloy or the combination thereof. In addition, ‘m’ satisfies 0<m≤2, ‘Q’ is alkali metal, alkaline earth metal, group 13 to group 16 elements, transition metal, a rare earth element, or the combination thereof, and Si is excluded from ‘Q’.

According to an embodiment of the present disclosure, the metal-based active material allowing the alloy with lithium may be, for example, B, Al, Ga, In, Ge, Sn, Pb, P, As, Sb, Bi, Mg, Ca, Zn, Cd, Pd, Ag, Au, Pt, the alloy thereof, or the oxide thereof.

According to an embodiment of the present disclosure, the lithium-containing active material may be, for example, a lithium-containing titanium composite oxide (LTO).

According to an embodiment of the present disclosure, the conductive material may include at least one selected from the group consisting of graphite, activated carbon, carbon black, acetylene black, Ketjen black, a carbon nano-tube, graphene and a carbon fiber.

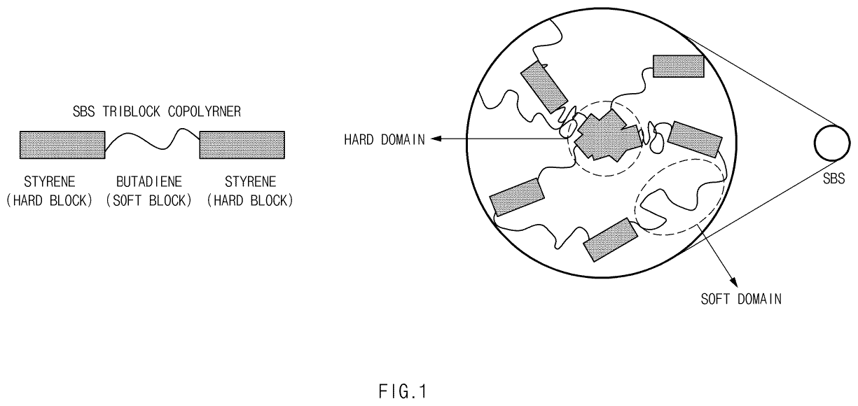

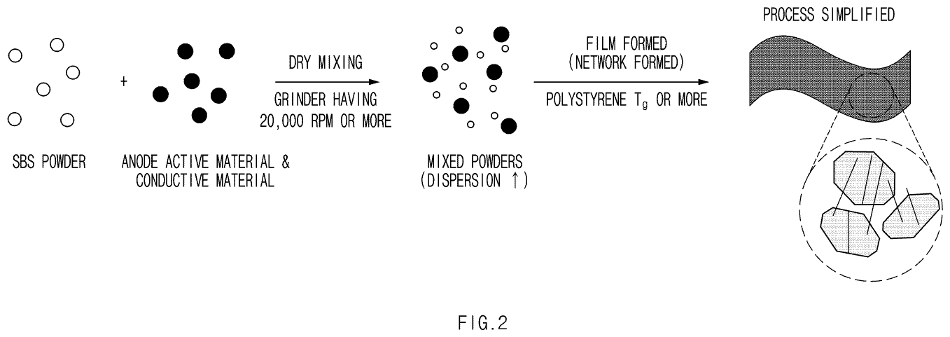

According to an embodiment of the present disclosure, as illustrated in FIG. 1, the binder may include a triblock copolymer including a soft block, which includes an aliphatic or cycloaliphatic diene monomer unit, and exhibits a rubbery phase at a room temperature, a first hard block, which is linked to one end of the soft block, includes an ethylenically unsaturated monomer unit containing an aromatic ring, and exhibits a glass phase at a room temperature, and a second hard block which is linked to another end of the soft block, includes an ethylenically unsaturated monomer unit containing an aromatic ring, and exhibits a glass phase at a room temperature.

According to an embodiment of the present disclosure, the soft block may apply excellent flexibility, extrusion moldability, and wear resistance to the triblock copolymer.

According to an embodiment of the present disclosure, the aliphatic or cycloaliphatic diene-based monomer for forming the aliphatic or cycloaliphatic diene-based monomer unit may be at least one selected from the group consisting of a butadiene-based monomer, a pentadiene-based monomer, and a hexadiene-based monomer.

According to an embodiment of the present disclosure, the butadiene-based monomer may include at least one selected from the group consisting of 1,2-butadiene, 1,3-butadiene, isoprene, and chloroprene.

According to an embodiment of the present disclosure, the pentadiene-based monomer may include at least one selected from the group consisting of 1,2-pentadiene, 1,3-pentadiene, 1,4-pentadiene, 2,3-pentadiene, 2-methyl-1,3-pentadiene, 2-methyl-1,4-pentadiene, 2-methyl-2,3-pentadiene, 2-methyl-2,4-pentadiene, 3-methyl-1,3-pentadiene, 3-methyl-1,4-pentadiene, 4-methyl-1,3-pentadiene, 2-ethyl-1,3-pentadiene, 2-ethyl-1,4-pentadiene, 2-ethyl-2,4-pentadiene, 3-ethyl-1,3-pentadiene, 3-ethyl-1,4-pentadiene, 4-ethyl-1,3-pentadiene, 1-chloro-1,3-pentadiene, 1-chloro-2,4-pentadiene, 2-chloro-1,3-pentadiene, 3-chloro-1,3-pentadiene, 3-chloro-1,4-pentadiene, and 5-chloro-1,3-pentadiene

According to an embodiment of the present disclosure, the hexadiene-based monomer may include at least one selected from the group consisting of 1,2-hexadiene, 1,3-hexadiene, 1,4-hexadiene, 1,5-hexadiene, 2,3-hexadiene, 2,4-hexadiene, 2,5-hexadiene, 3,5-hexadiene, 2-methyl-1,3-hexadiene, 2-methyl-1,4-hexadiene, 2-methyl-1,5-hexadiene, 2-methyl-2,3-hexadiene, 2-methyl-2,4-hexadiene, 3-methyl-1,2-hexadiene, 3-methyl-1,3-hexadiene, 3-methyl-1,4-hexadiene, 3-methyl-1,5-hexadiene, 3-methyl-2,4-hexadiene, 3-methyl-2,5-hexadiene, 4-methyl-1,3-hexadiene, 4-methyl-1,4-hexadiene, 4-methyl-2,3-hexadiene, 5-methyl-1,3-hexadiene, 5-methyl-1,4-hexadiene, 2-ethyl-1,3-hexadiene, 2-ethyl-1,4-hexadiene, 3-ethyl-1,2-hexadiene, 3-ethyl-1,3-hexadiene, 3-ethyl-1,4-hexadiene, 3-ethyl-1,4-hexadiene, and 3-ethyl-1,5-hexadiene.

According to an embodiment of the present disclosure, the first hard block and the second hard block may apply a higher-strength characteristic to the triblock copolymer.

According to an embodiment, an aromatic ring of an ethylenically unsaturated monomer containing the aromatic ring for forming an ethylenically unsaturated monomer unit containing an aromatic ring may be a substituted or unsubstituted benzene ring or a substituted or unsubstituted naphthalene ring.

According to an embodiment of the present disclosure, the aromatic ring may be linked to a main chain or a side chain of a repeating unit of the first hard block and the second hard block, and preferably to the side chain of the repeating unit of the first hard block and the second hard block.

According to an embodiment, the aromatic ring of the ethylenically unsaturated monomer containing the aromatic ring for forming the ethylenically unsaturated monomer unit containing the aromatic ring may be at least one selected from the group consisting of a styrene-based monomer and an aromatic (meth)acrylic monomer.

According to an embodiment of the present disclosure, the styrene-based monomer may include at least one selected from the group consisting of styrene, α-methylstyrene, p-methylstyrene, p-methoxystyrene, p-ethoxystyrene, t-butoxystyrene, p-acetoxystyrene, p-chlorostyrene, p-bromostyrene, 2,4-dimethylstyrene, 3,5-dimethylstyrene, and 2,4,6-trimethylstyrene.

According to an embodiment of the present disclosure, the aromatic (meth)acrylic monomer may include at least one selected from the group consisting of benzyl acrylate, benzyl methacrylate, phenoxy acrylate, phenoxy methacrylate, phenyl acrylate, phenyl methacrylate, phenylethyl acrylate and phenylethyl methacrylate.

According to an embodiment of the present disclosure, the first hard block and the second hard block may be strongly bound to the anode active material or the conductive material through a pi-pi interaction based on the structure of the aromatic ring contained in the ethylenically unsaturated monomer unit containing the aromatic ring. In addition, the first hard block and the second hard block may form a cross-link (connection) through physical binding showing relatively lower binding energy. For example, the first hard block and the second hard block maintain the shape and the size thereof at a glass transition temperature or less, but easily be mold above the glass transition temperature. Accordingly, when the free-standing film for the anode is manufactured at the temperature allowing the molding of the triblock copolymer, each hard block included in the triblock copolymer maintains the binding with the anode active material or the conductive material to be flexibly changed in shape. Accordingly, the binder section provides a physical crosslinking point (connecting point) having a linear shape (intermittent columnar or wire-like shape), and a robust three-dimensional network structure may be formed around the physical cross-link point.

According to an embodiment of the present disclosure, the content of the first hard block and the second hard block may range from about 10 wt % to about 60 wt %, preferably from about 15 wt % to about 55 wt %, and more particularly, about 20 wt % to about 50 wt %, based on the whole content of the triblock copolymer. When the content of the first hard block and the second hard block satisfies the numeric value range, the binding force may be more improved through the stronger interaction with the anode active material or the conductive material. In addition, the triblock copolymer may have a proper flexibility, such that the triblock copolymer has more excellent moldability.

According to an embodiment of the present disclosure, each of the first hard block and the second hard block may have a weight-average molar mass ranging from about 9,000 g/mol to about 20,000 g/mol, preferably, about 9,500 g/mol to about 20,000 g/mol, and more preferably, about 10,000 g/mol to about 20,000 g/mol. When the weight-average molar mass of each of the first hard block and the second hard block satisfies the numeric value range, the physical cross-linking force between the binder and the anode active material or the conductive material may be improved to more stably form a three-dimensional network, and the shape may be easily changed when the electrode is manufactured, such that the processability is more improved.

According to an embodiment of the present disclosure, each of the first hard block and the second hard block may have a glass transition temperature ranging from about 50° C. to about 120° C. The soft block may have a glass transition temperature ranging from about −120° C. to about −50° C. Preferably, each of the first hard block and the second hard block may have a glass transition temperature ranging from about 80° C. to about 120° C. The soft block may have a glass transition temperature ranging from about −120° C. to about −80° C. More preferably, each of the first hard block and the second hard block may have a glass transition temperature ranging from about 80° C. to about 110° C. The soft block may have a glass transition temperature ranging from about −110° C. to about −80° C. As each of the first hard block, the second hard block, and the soft block included in the triblock copolymer has the glass transition temperature within the numerical value range, a composition for forming the anode of the lithium secondary battery including the binder including the triblock copolymer may be more reversibly molded, the durability and the flexibility of the electrode manufactured from the composition may be more improved, and the shape of the electrode may be more effectively maintained.

According to an embodiment of the present disclosure, the soft block, the first hard block, and the second hard block included in the triblock copolymer may exhibit mutually independent properties without influence on each other. Accordingly, the soft block may provide flexibility to the free-standing film for the anode of a lithium secondary battery, which is a final product, and the first hard block and the second hard block may provide the stronger binding force with the anode active material to the free-standing film for the anode. In addition, since the soft block, and the first and second hard blocks have mutually different glass transition temperatures, when the free-standing film for the anode is formed (calendering) at the glass transition temperature or more of the first and second hard blocks, the triblock copolymer may be easily molded. Right after the free-standing film is formed, the free-standing film is exposed at the temperature less than the glass transition temperatures of the first and second hard blocks, and equal to or greater than the glass transition temperature of the soft block, the triblock copolymer has flexibility while maintaining higher strength. Accordingly, the free-standing film for the anode of the lithium secondary battery manufactured based on the triblock copolymer may be prevented from being easily broken by an external stimulation.

According to an embodiment of the present disclosure, the triblock copolymer is stabilized at a negative potential to suppress a side reaction. Accordingly, when the triblock copolymer is employed for the binder for the anode of the lithium secondary battery, the lifespan characteristic of the electrode may be improved.

According to an embodiment of the present disclosure, the average particle size (D₅₀) of the binder included in the powders for forming the anode, by grinding in ‘Si’ may be smaller than the average particle size (D₅₀) of the binder included in the composition for forming the anode. Accordingly, as described below, in the film forming process, the binder may be easily dispersed, and an average width perpendicular to a length direction of the binder having the column shape may be reduced.

According to an embodiment of the present disclosure, the binder (that is, the binder before grinding) included in the composition for forming the anode may have the average particle diameter (D₅₀) ranging from about 10 μm to about 50 μm. More specifically, the average particle diameter of the binder before grinding may be at least about 12 μm, at least about 14 μm, at least about 16 μm, at least about 18 μm, or at least about 20 μm. In addition, the average particle diameter may be at most about 48 μm, at most about 46 μm, at most about 44 μm, at most about 42 μm, or at most about 40 μm. In this case, the average particle diameter (D₅₀) of the binder may refer to a diameter corresponding to about 50% cumulative volume in the volume cumulative distribution measured by a laser diffraction/scattering type particle size distribution measuring device.

According to an embodiment of the present disclosure, the binder included in the composition for forming the anode has a substantially spherical shape, an authentic spherical shape, or an almost authentic spherical shape. Specifically, an average sphericity may range from about 0.7 to about 1.0, preferably about 0.8 to about 1.0, and more preferably from about 0.9 to about 1.0. In other words, the particles of the binder in the composition for forming the anode of the lithium secondary battery including the binder may maintain a substantially spherical shape and may be dispersed in the composition for forming the anode, before manufacturing the free-standing film for the anode.

In this case, the sphericity of the binder included in the composition for forming the anode is a value derived as an average value of ratios between a shorter diameter/a longer diameter of 10 binder particles randomly selected, after measuring a longer diameter and a shorter diameter of each of the binder particles based on an image of a binder particle, which is observed through a scanning electron microscope (SEM), calculating the ratio between the shorter diameter/longer diameter of each particle. In this case, it may be determined that the binder approaches the shape of a sphere, as the sphericity approaches ‘1’.

According to an embodiment of the present disclosure, in ‘S1’, mixing for the anode active material, the conductive material, and the binder may be performed through a grinder having revolutions per minute ranging from about 15,000 rpm to about 25,000 rpm, so the mixing and the grinding may be simultaneously performed.

According to an embodiment of the present disclosure, ‘Si’ may be performed for at most about 5 minutes. Specifically, ‘S1’ may be performed for at most about 4 minutes, at most about 3 minutes, at most about 2 minutes, or at most about one minute.

According to an embodiment of the present disclosure, as illustrated in FIG. 1, as the binder is ground by the grinder, the particle diameter of the binder may be reduced. The average particle diameter (D₅₀) of the binder (that is, binder ground) included in powders for forming the anode, which is a result in ‘S1’ may range from about 1 μm to about 5 μm. More specifically, the average particle diameter of the binder ground may be at least about 1.1 μm, at least about 1.2 μm, at least about 1.3 μm, or at least about 1.4 μm. In addition, the average particle diameter may be at most about 4.5 μm, at most about 4 μm, at most about 3.5 μm, at most about 3 μm, or at most about 2 μm. The average diameter (D₅₀) of the binder here refers to a diameter corresponding to about 50% cumulative volume in the volume cumulative distribution measured by a device to measure laser diffraction/scattering type particle size distribution. Meanwhile, the anode active material and the conductive material are less ground by the grinder. Accordingly, the particle diameter of the anode active material and the conductive material may be almost maintained without being changed.

As described above, as the binder is ground to have a smaller particle diameter by the grinder, the binder may be more excellently dispersed into the powders for forming the anode. Accordingly, the tensile force of the free-standing film for the anode manufactured may be enhanced.

### 2. ‘S2’

According to an embodiment of the present disclosure, the method for manufacturing the free-standing film for the anode may include the step for forming the anode active material layer through the film forming process using powers for forming the anode, which are obtained in ‘S1’, (S2).

According to an embodiment of the present disclosure, the film forming process may be performed through a dry manner. In other words, the composition for forming the anode of the lithium secondary battery, which is used in the film forming process, may not include a solvent actually. The film forming process, which is performed through a wet manner, has a limitation in increasing a loading amount of an electrode, and has a difficulty in forming a network structure between the binder and an active material/conductive material due to liquid-phase slurry. However, according to an embodiment of the present disclosure of the present disclosure, the film forming process performed through the dry manner may make it possible to increase the loading amount of the electrode to implement a higher energy density, thereby manufacturing a lithium secondary battery having a network structure effectively formed between the binder and the active material.

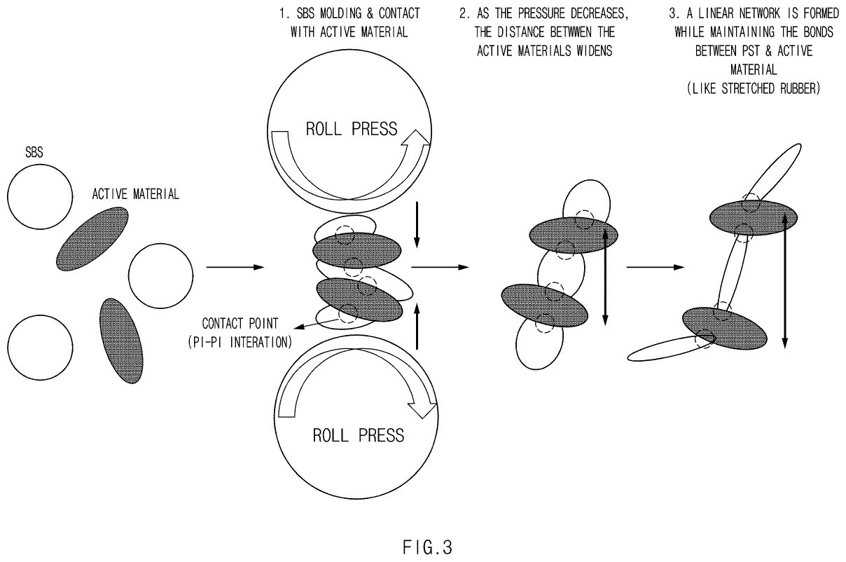

According to an embodiment of the present disclosure, the film forming process may include a calendering (rolling) process (rolling process). In other words, as illustrated in FIG. 3, the anode active material layer may be formed by allowing the composition for forming the anode of the lithium secondary battery, which includes the anode active material, the conductive material, and the binder, to pass between a pair of rollers, and pressing and rolling the composition. In this case, the roller may have the diameter ranging from about 50 mm to about 1000 mm, preferably, ranging from about 100 mm to about 1000 mm, and more preferably, ranging from about 100 mm to about 500 mm.

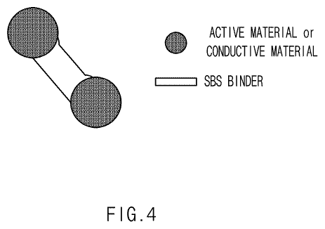

According to an embodiment of the present disclosure, the network structure between the binder and the active material is formed through the film forming process. In this case, the network structure between the binder and the active material may refer to a network structure in an intermittent column shape in which the binder links an anode active material or a conductive material and another anode active material or a conductive material, as illustrated in FIG. 4. In other words, as the binder having the shape of the column (or wire), which is not continuous, links an external surface of any one active material or conductive material, to an external surface of another active material or conductive material, the complex of a three-dimensional network structure having a net shape (the active material or the conductive material is positioned at a crossing point, and a linear-type binder links the active materials or the conductive materials to each other) may be formed. Such a three-dimensional network may be made due to the stronger pi-pi interaction between the first hard block and the second hard block, which are included in the triblock copolymer, and the anode active material or the conductive material.

In addition, the binder including the triblock copolymer makes contact with the anode active material or the conductive material due to higher external force (shearing force or tensile force) at the initial stage of the film forming process. Thereafter, as the external force is lowered at the later stage of the film forming process, the distance from the anode active material or the conductive material is increased. Accordingly, the binder including the triblock copolymer, which is in contact with the surface of the anode active material or the conductive material, may be flexibly changed in shape while maintaining the link to the anode active material or the conductive material, so the binder may have a linear shape such as an intermittent column shape or a wire shape.

In addition, the triblock copolymer may receive pressure at a temperature allowing the film forming process and be changed to be in a column shape such that the three-dimensional network is formed. The active material or the conductive material and the binder having the intermittent column shape are linked to each other to form the three dimensional network, thereby manufacturing the free-standing film for the anode of the lithium secondary battery having excellent tensile force.

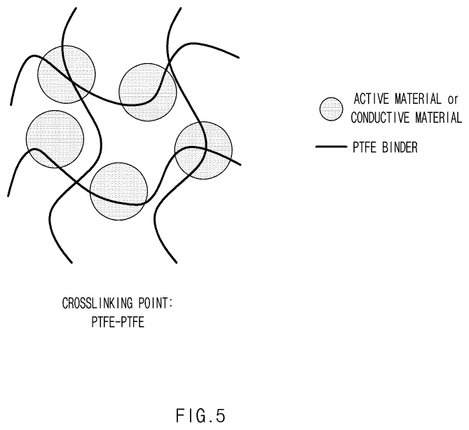

FIG. 5 is a view schematically illustrating the structure formed by the binder and the anode active material in the conventional free-standing film for the anode employing PTFE as a binder. As illustrated in FIG. 5, the binder is not linked to the anode active material, which is different from an embodiment of the present disclosure employing the triblock copolymer as the binder. In other words, the conventional free-standing film for the anode makes a difference from the present disclosure, in that a link between the PTFE binders is formed to form a network structure, and the anode active material is randomly overlapped and positioned without a point contact on the network structure (in this case, a portion shown in the form of faint lines partially obscured by the active particles corresponds to the network structure of the PTFE binder).

According to an embodiment of the present disclosure, the binder contained in the powders for forming the anode used in the film forming process is ground to obtain an average particle diameter ranging from about 1 μm to about 5 μm in ‘S1’ as described above. Accordingly, the binder may be more excellently dispersed in the powders for forming the anode, thereby improving the tensile force of the free-standing film for the anode.

In addition, as the average particle diameter of the binder contained in the powders for forming the anode used in the film forming process satisfies the range from about 1 μm to about 5 μm, the binder having the three-dimensional network structure in the free-standing film for the anode and the intermittent column shape to link any one anode active material or conductive material, and another anode active material or conductive material may have an average width of at most about 50 nm perpendicular to the length direction.

According to an embodiment of the present disclosure, the calendering may be performed at a temperature equal to or higher than a first glass transition temperature and a second glass transition temperature corresponding to the first hard block and the second hard block, respectively. Specifically, the calendering may be performed at a temperature ranging from about 50° C. to about 140° C., preferably, about 80° C. to about 140° C., and more preferably about 80° C. to about 130° C. Accordingly, the moldability of the triblock copolymer including the first hard block and the second hard block and the binder including the same may be more improved.

According to an embodiment of the present disclosure, external force, such as shear force or external force, is applied through the calendering, the free-standing film for the anode of the lithium secondary battery may be manufactured at the final stage.

Specifically, the anode active material layer manufactured in the dry manner may be a free-standing anode active material layer. The free-standing anode active material layer may be an anode active material layer (that is, a free-standing film for the anode) having a membrane form or a film form manufactured to self-maintain a specific shape without being supported to another base. The above-described free-standing film for the anode is manufactured, thereby smoothly performing a subsequent lamination process to manufacture the anode for the lithium secondary battery.

### <Free-Standing Film for Anode>

The present disclosure provides a free-standing film for an anode manufactured through the method for manufacturing the free-standing film for the anode.

According to an embodiment of the present disclosure, the free-standing film for the anode includes a plurality of anode active materials, a plurality of conductive materials, and a binder, and the binder includes a triblock copolymer including a soft block, which includes an aliphatic or cycloaliphatic diene-based monomer unit, and exhibits a rubbery phase at a room temperature, a first hard block, which is linked to one end of the soft block, includes an ethylenically unsaturated monomer unit containing an aromatic ring, and exhibits a glass phase at the room temperature, and a second hard block which is linked to another end of the soft block, includes an ethylenically unsaturated monomer unit containing an aromatic ring, and exhibits a glass phase at the room temperature. The binder has an intermittent column shape to link any one anode active material among the plurality of anode active materials or any one conductive material among the plurality of conductive materials, and another anode active material among the plurality of anode active materials or a conductive material among the plurality of conductive materials, and has an average width of about 50 nm perpendicular to the length direction.

The anode active materials, the conductive material, and the binder included in the free-standing film for the anode according to an embodiment of the present disclosure have been already described in the description about the method for manufacturing the free-standing film for the anode, so the details thereof will be omitted.

According to an embodiment of the present disclosure, the binder having a column shape and included in the free-standing film for the anode may have the average width perpendicular to the length direction, which ranges from at most about 45 nm, at most about 40 nm, at most about 35, at most about 30 nm, or at most about 25 nm, and at least about 5 nm, at least about 10 nm, at least about 15 nm, or at least about 20 nm. The binder included in the free-standing film for the anode may have the average width perpendicular to the length direction, which satisfies the above range, as particles of the binder are ground before the film forming process in ‘S1’. As the binder in the free-standing film for the anode is excellently dispersed such that the above-described three-dimensional structure is uniformly formed, the free-standing film for the anode is excellent in both tensile force in a machine direction (MD) and tensile force in a transverse direction (TD).

According to an embodiment of the present disclosure, when an electron beam of 5.0 kV is irradiated to the free-standing film for the anode for at least one second to obtain a scanning electron microscope (SEM) image, a fused structure having an average width of about 30 nm, which is perpendicular to the length direction, is observed on the surface of the anode active material or the surface of the conductive material. The fused structure may include a triblock copolymer including a soft block, which includes an aliphatic or cycloaliphatic diene-based monomer unit, and exhibits a rubbery phase at a room temperature, a first hard block, which is linked to one end of the soft block, includes an ethylenically unsaturated monomer unit containing an aromatic ring, and exhibits a glass phase at a room temperature, and a second hard block which is linked to another end of the soft block, includes an ethylenically unsaturated monomer unit containing an aromatic ring, and exhibits a glass phase at a room temperature.

According to an embodiment of the present disclosure, when the electron beam of at least 5.0 kV is irradiated to the free-standing film for the anode to obtain the scanning electron microscope (SEM) image, the fused structure may be referred to as a portion, which is fused on the surface of the anode active material or the surface of the conductive material, of the binder, as a portion, which has the average width of about 30 nm or less, of the binder having the shape of a column and included in the free-standing film for the anode is melted by the electron beam. Accordingly, since the fused structure has a composition the same as a composition of the binder included in the free-standing film for the anode, the details of the composition of the fused structure will be omitted.

According to an embodiment of the present disclosure, the average thickness of the free-standing film for the anode may range from about 30 μm to about 500 μm, preferably, range from about 50 μm to about 300 μm, and more preferably range from about 70 μm to about 200 μm.

### <Anode for Lithium Secondary Battery>

According to another embodiment of the present disclosure, there is provided an anode for a lithium secondary battery, which includes a current collector and a free-standing film for the anode of the lithium secondary battery, which is provided on the current collector.

When the free-standing film for the anode of the lithium secondary battery is formed through the film forming process, the free-standing film may be provided on the current collector to be laminated. The lamination may be performed according to a lamination roll. In this case, the lamination roll may be maintained at the temperature of 80° C. to 200° C. The free-standing film for the anode of the lithium secondary battery and the current collector may be bonded to each other through such a lamination process.

The current collector is not particularly limited as long as the current collector has high conductivity without causing a chemical change in a battery. For example, the current collector may include stainless steel, aluminum, nickel, titanium, sintered carbon, copper, aluminum, or the alloy thereof, or a material obtained by performing surface-treatment for a stainless steel surface with carbon, nickel, titanium, or silver.

### <Lithium Secondary Battery>

According to another embodiment of the present disclosure, there is provided a lithium secondary battery including an anode for the lithium secondary battery, a cathode for the lithium secondary battery, and an electrolyte.

The cathode for the lithium secondary battery may include at least one cathode active material selected from the group consisting of lithium, nickel, cobalt, manganese, iron, tin, silicon, aluminum, and the mixture thereof. More specifically, the cathode for the lithium secondary battery may be applied with a cathode active material such as LiCoO₂, LiMnO₂, LiFeO₂, Li(Ni_{0.6}Mn_{0.2}Co_{0.2})O₂, Li(Ni_{0.7}Mn_{0.15}Co_{0.15})O₂, Li(Ni_{0.8}Mn_{0.1}Co_{0.1})O₂, Li(Ni_{0.9}Mn_{0.05}Co_{0.05}) O₂, LiNi_{0.6}Co_{0.2}0A1_{0.2}O₂, LiNi_{0.7}Co_{0.2}0Al_{0.1}O₂, LiNi_{0.8}Co_{0.15}Al_{0.05}O₂, LiNi_{0.85}Co_{0.1}Al_{0.05}O₂, LiNi_{0.88}Co_{0.1}Al_{0.02}O₂, LiMn₂O₄, LiFePO₄.

The electrolyte may be a liquid electrolyte or a solid electrolyte.

When the electrolyte is the liquid electrolyte, the electrolyte may include a lithium salt and a non-aqueous organic solvent.

The lithium salt may include various lithium salts, as long as the various lithium salts are commonly employed for the electrolyte for the lithium secondary battery. For example, the lithium salt may include at least one compound selected from the group consisting of LiPF₆, LiBF₄, LiSbF₆, LiAsF₆, LiN(C₂F₅SO₂)₂, LiN(CF₃SO₂)₂, CF₃SO₃Li, LiC(CF₃SO₂)₃, LiC₄BO₈, LiTFSI, LiFSI, and LiClO₄.

The non-aqueous organic solvent may include an organic solvent in a type usable as the non-aqueous electrolyte when the typical lithium secondary battery is manufactured. In this case, the content of the non-aqueous organic solvent may be properly adjusted within a typically usable range.

Specifically, the non-aqueous organic solvent may include typical organic solvents, such as a cyclic carbonate solvent, a linear carbonate solvent, an ester solvent, or a ketone solvent, which may be used as a non-aqueous organic solvent of the lithium secondary battery. The non-aqueous organic solvent may not only solely include the typical organic solvents, but also the mixture of at least two of the typical organic solvents.

The cyclic carbonate solvent may include at least one selected from the group consisting of ethylene carbonate (EC), vinylene carbonate (VC), fluoroethylene carbonate (FEC), propylene carbonate (PC), and butylene carbonate (BC).

The linear carbonate solvent may include at least one selected from the group consisting of dimethyl carbonate (DMC), diethyl carbonate (DEC), dipropyl carbonate (DPC), ethylmethyl carbonate (EMC), methylpropyl carbonate (MPC) and ethylpropyl carbonate (EPC).

The ester solvent may include at least one selected from the group consisting of methyl acetate, ethyl acetate, propyl acetate, methyl propionate, ethyl propionate, γ-butyrolactone, γ-valerolactone, γ-caprolactone, δ-valerolactone and ε-caprolactone.

The ketone solvent may include polymethylvinyl ketone.

When the electrolyte is the liquid electrolyte, the lithium secondary battery may include a separator.

The separator may solely include a porous polymer film, which is commonly used, prepared using, for example, a polyolefin-based polymer such as an ethylene homopolymer, a propylene homopolymer, an ethylene/butene copolymer, an ethylene/hexene copolymer, and an ethylene/methacrylate copolymer, or include porous polymer films laminated on each other. Alternatively, the separator may employ a common porous nonwoven fabric, such as a glass fiber having a higher melting point, or a polyethylene terephthalate fiber, but the present disclosure is not limited thereto. In addition, a coated separator containing ceramic components or polymer materials may be used to secure heat resistance or mechanical strength, and may be optionally used in a single-layer structure or a multi-layer structure.

In this case, a pore diameter of the porous separator may typically have a pore diameter ranging about 0.01 μm to about 50 μm, and a porosity ranging from about 5% to about 95%. In addition, the thickness of the porous separator may typically range from about 5 μm to about 300 μm.

Meanwhile, when the electrolyte is a solid electrolyte, the electrolyte may be a polymer-based solid electrolyte, an oxide-based solid electrolyte, a sulfide-based solid electrolyte, or the mixture thereof.

The polymer-based solid electrolyte may include a polyether-based polymer, a polycarbonate-based polymer, an acrylate polymer, a polysiloxane-based polymer, a phosphagen-based polymer, a polyethylene derivative, an alkylene oxide derivative, such as a polyethylene oxide, a phosphoric acid ester polymer, polyediation lysine, a polyester sulfide, polyvinyl alcohol, a polyvinylidene fluoride and a derivative thereof, or a polymer containing an ionic dissociation group. In addition, the polymer electrolyte may include, for example, a branched copolymer, a comb-like polymer, and a crosslinked polymer obtained by copolymerizing an amorphous polymer, such as PMMA, polycarbonate, polysiloxane, and/or phosphazene, which serves as a comonomer to a polyethylene oxide (PEO) main chain as a polymer resin, and may include at least one among them.

The oxide-based solid electrolyte may include, for example, a LLZO-based compound, a LLTO-based compound such as Li₃ₓLa_{2/3-x}TiO₃, a LISICON-based compound such as Li₁₄Zn(GeO₄)₄, a LATP-based compound such as Li_{1.3}Al_{0.3}Ti_{1.7} (PO₄)₃, a LAGP-based compound such as (Li₁₊ₓGe₂₋ₓAlₓ (PO₄)₃), or a LIPON-based compound, but the present disclosure is not limited thereto.

The sulfide-based solid electrolyte may include at least one of Li₆PS₅Cl, Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂SLi₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, or Li₂S—GeS₂—ZnS, but the present disclosure is not limited thereto.

Hereinafter, an embodiment of the present disclosure will be described in detail such that those skilled in the art may easily reproduce the embodiment of the present disclosure. However, the present disclosure may be implemented in various forms, and is limited to embodiments described herein.

### Example 1

Graphite serving as the anode active material, carbon serving as the conductive material, an SBS triblock copolymer serving as the binder (a glass transition temperature of a polystyrene block: 100° C., a glass transition temperature of a polybutadiene block: −100° C.), which have the mass ratio of 96:1:3, were mixed and ground without a solvent at 20,000 rpm or more by a grinder for one minute, thereby obtaining powders for forming the anode.

The obtained powder for forming the anode was rolled using a two-roll press heated to 120° C. to manufacture the free-standing film for the anode.

### Comparative Example 1

Graphite serving as the anode active material, carbon serving as the conductive material, an SBS triblock copolymer serving as the binder (a glass transition temperature of a polystyrene block: 100° C., a glass transition temperature of a polybutadiene block: −100° C.), which have the mass ratio of 96:1:3, were mixed without a solvent for eight minutes.

The mixed powder was rolled using a two-roll press heated to 120° C. to manufacture the free-standing film for the anode.

### Comparative Example 2

Graphite serving as the anode active material, carbon serving as the conductive material, an SBS triblock copolymer serving as the binder (a glass transition temperature of a polystyrene block: 100° C., a glass transition temperature of a polybutadiene block: −100° C.), which have the mass ratio of 96:1:3, were mixed without a solvent for eight minutes. The mixed powder was rolled using a two-roll press heated to 120° C. to manufacture the free-standing film to be ground.

The free-standing film to be ground, which was formed through the film forming process, was ground by using a grinder to apply shearing force, for 22 minutes, mixed powers produced through the grinding were put into a roller again, and a temperature of at least 100° C. was applied to the result while performing the film forming process to manufacture the free-standing film for the anode.

### Experimental Example 1: SEM Image Observed for Powders for Forming Anode

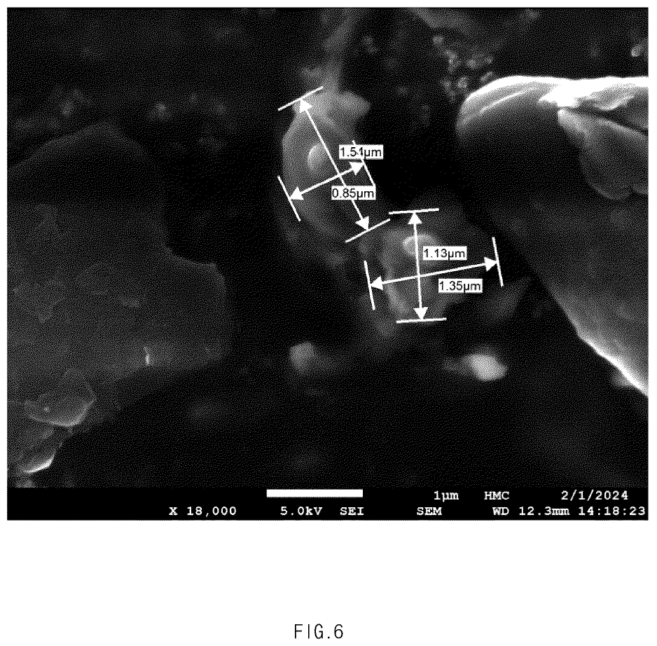

The SEM image for powders for forming the anode according to Example 1 is illustrated in FIG. 6.

### Experimental Example 2: SEM Image Observed for Free-Standing Film for Anode

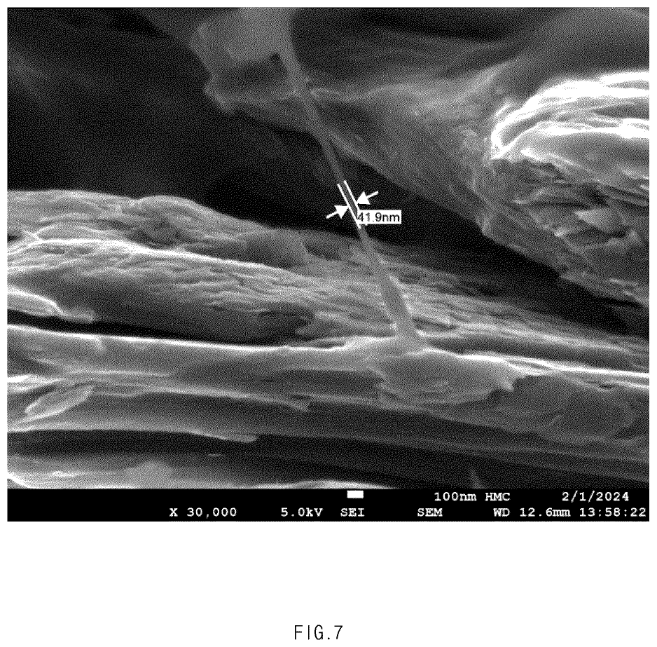

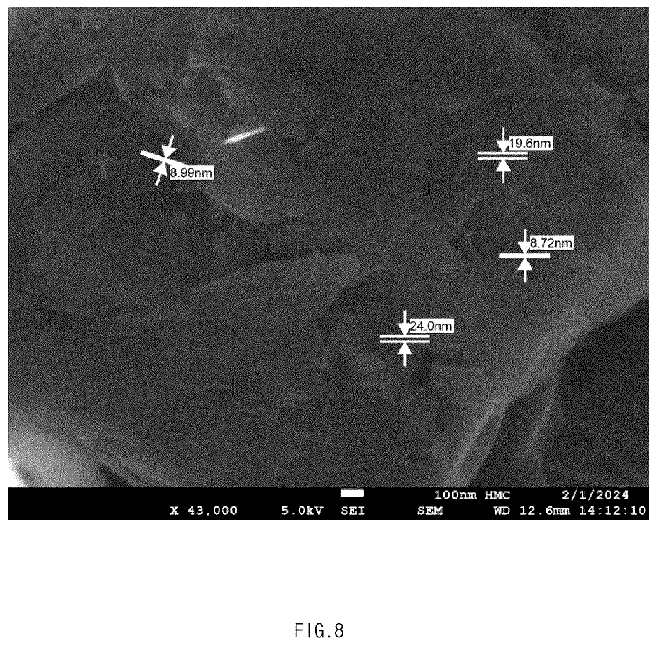

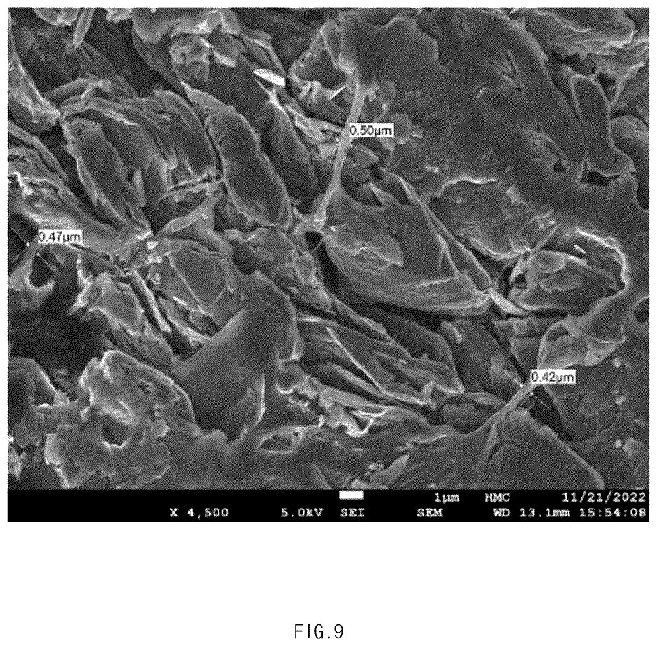

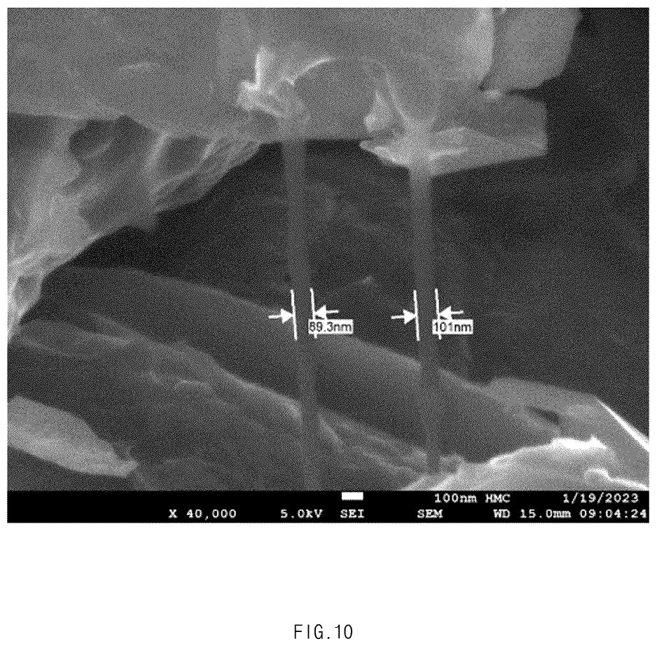

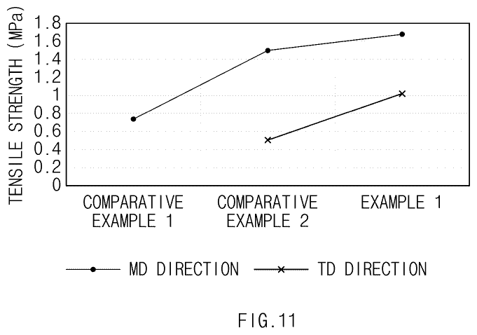

SEM images were obtained by irradiating an electron beam of 5.0 kV to the free-standing films for the anode manufactured according to Example 1, and Comparative examples 1 and 2. The SEM images the free-standing films for the anode manufactured according to Example 1, and Comparative examples 1 and 2 were illustrated in FIGS. 7 to 10.

Referring to FIGS. 7 to 10, the free-standing film for the anode according to Example 1 was formed in the state that the binder powders were ground. Accordingly, it may be recognized that the width of the binder having the column shape was 50 nm or less, which is thinner than the width of the binders having the column shape in the free-standing films for the anode according to Comparative examples 1 and 2 in binder powders were not ground.

Accordingly, it may be observed that the binder having the column shape and the width of about 30 nm or less is melted on the surface of the anode active material or the surface of the conductive material by the electron beam to form the fused structure, when the SEM image is obtained by irradiating the electron beam of 5.0 kV for two seconds according to Example 1. Meanwhile, the binder having the column shape according to Comparative examples 1 and 2 has the width ranging from about 0.2 μm to about 2 μm, which are significantly thicker than Example 1. Accordingly, the fused structure formed by the electron beam is not observed in the binder having the column shape according to Comparative examples 1 and 2.

### Experimental Example 3: Tensile Force of Free-Standing Film for Anode Measured

Each of free-standing films for the anode manufactured according to Example 1, and Comparative examples 1 and 2 was punched in a width of 2 cm and a length of 6 cm and prepared. Thereafter, the result was measured in tensile force at the rate of 5 mm/min using UTM equipment, and the measurement value is shown following Table 1.

TABLE 1

| | | | | Tensile force | |
|---|---|---|---|---|---|
| | Loading | Binder | Mixing | (MPa) | |
| | amount | content | time | MD | TD |
| Classification | (mg/cm²) | (wt %) | (min) | direction | direction |
| Example 1 | 20 | 3 | 1 | 1.68 | 1.01 |
| Comparative | | | 8 | 0.73 | Non- |
| example 1 | | | | | measurable |
| Comparative | | | 30 | 1.50 | 0.51 |
| example 2 | | | | | |

Referring to Table 1, it may be recognized the free-standing film for the anode according to Example 1 exhibited shorter mixing time and more improved tensile force in the MD direction and TD direction, as compared with the free-standing films for the anode according to Comparative examples 1 and 2. Particularly, the free-standing film for the anode according to Example 1 exhibited improved tensile force in TD direction, which may be determined in that the tensile force in the TD direction according to Comparative example 1 was significantly lower and immeasurable, and the tensile force in the TD direction according to Comparative example 2 was half of the tensile force in the TD direction according to Example 1.

In the method for manufacturing the free-standing film for the anode according to an example of the present disclosure, the free-standing film for the anode of the lithium secondary battery, the anode for the lithium secondary battery using the same, and the lithium secondary battery may be manufactured in which the free-standing film is bound to the anode active material or the conductive material through the stronger interaction and electro-chemically stabilized at the negative potential while exhibiting the excellent tensile force, and a property of easily being molded.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for manufacturing a free-standing film for an anode, the method comprising:
obtaining powders for forming the anode by mixing and grinding a composition for forming the anode including an anode active material, a conductive material, and a binder (S1); and
forming an anode active material layer through a film forming process using the powders for forming the anode (S2),
wherein the binder includes a triblock copolymer, the triblock copolymer including:
a soft block that includes an aliphatic or cycloaliphatic diene monomer unit, and exhibits a rubbery phase at a room temperature,
a first hard block that is linked to one end of the soft block, includes an ethylenically unsaturated monomer unit containing an aromatic ring, and exhibits a glass phase at a room temperature, and
a second hard block that is linked to another end of the soft block, includes an ethylenically unsaturated monomer unit containing an aromatic ring, and exhibits the glass phase at the room temperature, and
wherein an average particle diameter (D₅₀) of the binder included in the powders for forming the anode is smaller than an average particle diameter (D₅₀) of the binder included in the composition for forming the anode.

2. The method of claim 1, wherein the binder included in the composition for forming the anode has a spherical shape, and an average sphericity ranges from 0.8 to 1.0.

3. The method of claim 1, wherein the binder included in the composition for forming the anode includes a particle having an average particle diameter (D₅₀) ranging from 10 μm to 50 μm.

4. The method of claim 1, wherein ‘S1’ is performed through a grinder, and
wherein the grinder has revolutions per minute (RPM) ranging from 15,000 rpm to 25,000 rpm.

5. The method of claim 1, wherein the binder included in the powders for forming the anode includes a particle having an average particle diameter (D₅₀) ranging from 1 μm to 5 μm.

6. The method of claim 1, wherein the film forming process is performed in a dry manner.

7. The method of claim 6, wherein the film forming process includes calendering, and
wherein the calendering is performed at a temperature equal to or higher than a first glass transition temperature and a second glass transition temperature corresponding to the first hard block and the second hard block, respectively.

8. The method of claim 1, wherein each of the first hard block and the second hard block has a glass transition temperature ranging from 50° C. to 120° C., and
wherein the soft block has a glass transition temperature ranging from −120° C. to −50° C.

9. The method of claim 1, wherein an aliphatic or cycloaliphatic diene monomer for forming the aliphatic or cycloaliphatic diene monomer unit is at least one selected from the group consisting of a butadiene-based monomer, a pentadiene-based monomer, and a hexadiene-based monomer.

10. The method of claim 1, wherein an ethylenically unsaturated monomer containing the aromatic ring for forming the ethylenically unsaturated monomer unit containing the aromatic ring is at least one selected from the group consisting of a styrene-based monomer and an aromatic (meth)acrylic monomer.

11. A free-standing film for an anode, the free-standing film comprising:
a plurality of anode active materials, a plurality of conductive materials, and a binder,
wherein the binder includes a tri block copolymer, the triblock copolymer including:
a soft block that includes an aliphatic or cycloaliphatic diene monomer unit, and exhibits a rubbery phase at a room temperature,
a first hard block that is linked to one end of the soft block, includes an ethylenically unsaturated monomer unit containing an aromatic ring, and exhibits a glass phase at a room temperature, and
a second hard block that is linked to another end of the soft block, includes an ethylenically unsaturated monomer unit containing an aromatic ring, and exhibits the glass phase at the room temperature,
wherein the binder has an intermittent column shape to link one anode active material among the plurality of anode active materials or one conductive material among the plurality of conductive materials, to another anode active materials among the plurality of anode active materials or another conductive material among the plurality of conductive materials, and
wherein the binder has an average width of 50 nm perpendicular to a length direction.

12. The free-standing film of claim 11, wherein a surface of the anode active material or a surface of the conductive material comprises a fused structure perpendicular to the length direction of the surface having an average width less than or equal to 30 nm, when an electron beam of 5.0 kV is irradiated to the free-standing film for the anode for at least one second to obtain a scanning electron microscope (SEM) image, and
wherein the fused structure includes the triblock copolymer.

13. The free-standing film of claim 11, wherein each of the first hard block and the second hard block has a glass transition temperature ranging from 50° C. to 120° C., and
wherein the soft block has a glass transition temperature ranging from −120° C. to −50° C.

14. The free-standing film of claim 11, wherein an aliphatic diene monomer for forming the aliphatic diene monomer unit is at least one selected from the group consisting of a butadiene-based monomer, a pentadiene-based monomer, and a hexadiene-based monomer.

15. The free-standing film of claim 11, wherein an ethylenically unsaturated monomer containing the aromatic ring for forming the ethylenically unsaturated monomer unit containing the aromatic ring is at least one selected from the group consisting of a styrene-based monomer and an aromatic (meth)acrylic monomer.

16. An anode for a lithium secondary battery comprising:
a current collector; and
a free-standing film for the anode according to claim 11, which is provided on the current collector.

17. A lithium secondary battery comprising:
an anode for the lithium secondary battery according to claim 16;
a cathode for the lithium secondary battery; and
an electrolyte.

18. An anode for a lithium secondary battery comprising:
a current collector; and
a free-standing film for the anode according to claim 12, which is provided on the current collector.

19. An anode for a lithium secondary battery comprising:
a current collector; and
a free-standing film for the anode according to claim 13, which is provided on the current collector.

20. An anode for a lithium secondary battery comprising:
a current collector; and
a free-standing film for the anode according to claim 14, which is provided on the current collector.
